(19) United States
(12) Patent Application Publication
(10) Pub. No.: US 2011/0153306 A1
(43) Pub. Date: Jun. 23, 2011

(54) SYSTEM, METHOD AND COMPUTER PROGRAM PRODUCT FOR PROCESSOR VERIFICATION USING ABSTRACT TEST CASE

(75) Inventors: Sangram ALAPATI, Austin, TX (US); Satish Kurmar Sadasivam, Erode (IN); Madhavan Srinivasan, Chennai (IN); Jubilee Bhavam Ponna, Andhra Pradesh (IN); Harish P. Omkar, Gulbarga (IN)

(73) Assignee: INTERNATIONAL BUSINESS MACHINES CORPORATION, Armonk, NY (US)

(21) Appl. No.: 12/645,836

(22) Filed: Dec. 23, 2009

(51) Int. Cl. G06F 9/44

(52) U.S. Cl. 703/21

(57) ABSTRACT

According to one aspect of the present disclosure a method and technique for processor verification using an abstract test case is disclosed. The method comprises identifying a format for an abstract instruction of an abstract test case, selecting an instruction from an instruction pool corresponding to the identified format, and generating a real test case for processor verification by modifying the abstract instruction based on the instruction selected from the instruction pool.

### BACKGROUND

Processor verification or validation is performed to verify the proper operation of a hardware component. One such method of processor verification includes simulation based verification. In this method, a test case is built and executed by the hardware. Also, the test case is simulated using software. The results of the hardware execution are compared to the software simulation to verify the hardware operation.

### BRIEF SUMMARY

According to one aspect of the present disclosure a method and technique for processor verification using an abstract test case is disclosed. The method comprises identifying a format for an abstract instruction of an abstract test case, selecting an instruction from an instruction pool corresponding to the identified format, and generating a real test case for processor verification by modifying the abstract instruction based on the instruction selected from the instruction pool.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is an embodiment of a network of data processing systems in which the illustrative embodiments of the present disclosure may be implemented;

FIG. 2 is an embodiment of a data processing system in which the illustrative embodiments of the present disclosure may be implemented;

FIG. 3 is a diagram illustrating an embodiment of a processor verification system in accordance with aspects of the present disclosure;

FIG. 4 is a diagram illustrating several embodiments of abstract instructions in accordance with aspects of the present disclosure;

FIG. 5 is a diagram illustrating an embodiment of an instruction word in accordance with embodiments of the present disclosure;

FIG. 6 is a flow diagram illustrating an embodiment of a method for abstract instruction building in accordance with aspects of the present disclosure; and

FIG. 7 is a flow diagram illustrating an embodiment of a method for building a real processor verification test case from an abstract test case in accordance with aspects of the present disclosure.

### DETAILED DESCRIPTION

Embodiments of the present disclosure provide a method, system and computer program product for processor verification by building an abstract test case and using the abstract test case to build a real test case. The abstract test case includes one or more abstract instructions that may be modified, replaced or substituted with non-abstract or real instructions from an instruction pool of real instructions. Based on the format of the abstract instruction, different real instructions may be selected from the instruction pool. Thus, the present disclosure enables a number of different test cases or test streams to be built from an abstract test case by selecting different instructions from a format-based instruction pool. Accordingly, embodiments of the present disclosure enable a reduction in the instruction build and build time simulation complexities by enabling different instruction streams to be built from a single abstract test case. Further, embodiments of the present disclosure enable verifying instructions corresponding to particular instruction formats with a minimum number of test cases.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer usable or computer readable medium(s) may be utilized. The computer readable medium may be a computer readable signal medium or a computer readable storage medium. A computer readable storage medium may be, for example but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

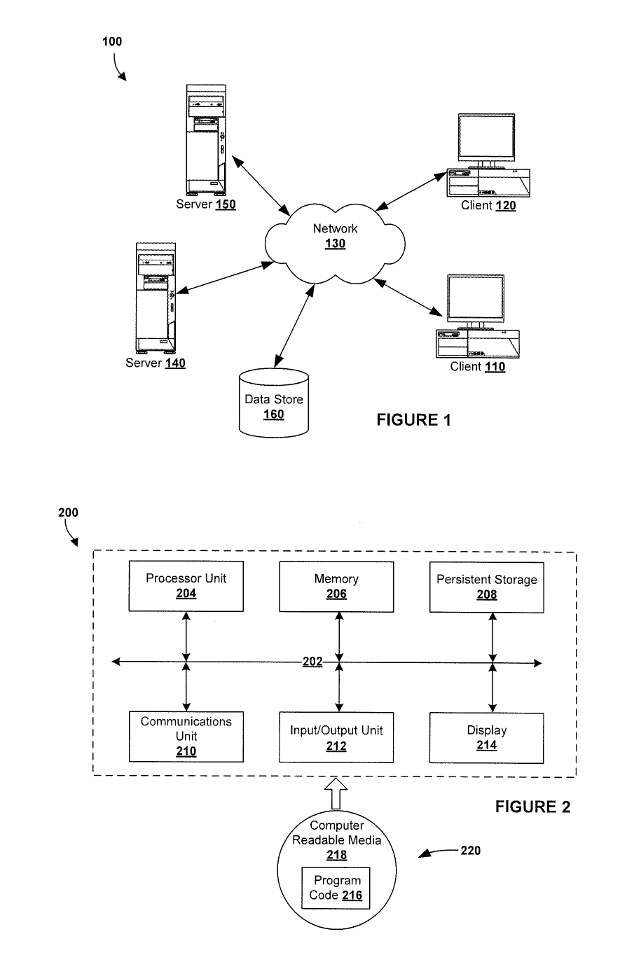

With reference now to the Figures and in particular with reference to FIGS. 1-2, exemplary diagrams of data processing environments are provided in which illustrative embodiments of the present disclosure may be implemented. It should be appreciated that FIGS. 1-2 are only exemplary and are not intended to assert or imply any limitation with regard to the environments in which different embodiments may be implemented. Many modifications to the depicted environments may be made.

FIG. 1 is a pictorial representation of a network of data processing systems in which illustrative embodiments of the present disclosure may be implemented. Network data processing system 100 is a network of computers in which the illustrative embodiments of the present disclosure may be implemented. Network data processing system 100 contains network 130, which is the medium used to provide communications links between various devices and computers connected together within network data processing system 100. Network 130 may include connections, such as wire, wireless communication links, or fiber optic cables.

In some embodiments, server 140 and server 150 connect to network 130 along with data store 160. Server 140 and server 150 may be, for example, IBM System p® servers. In addition, clients 110 and 120 connect to network 130. Clients 110 and 120 may be, for example, personal computers or network computers. In the depicted example, server 140 provides data and/or services such as, but not limited to, data files, operating system images, and applications to clients 110 and 120. Network data processing system 100 may include additional servers, clients, and other devices.

In the depicted example, network data processing system 100 is the Internet with network 130 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

FIG. 2 is an embodiment of a data processing system 200 such as, but not limited to, client 110 in which an embodiment of a window navigation application according to the present disclosure may be implemented. In this embodiment, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

In some embodiments, memory 206 may be a random access memory or any other suitable volatile or non-volatile storage device. Persistent storage 208 may take various forms depending on the particular implementation. For example, persistent storage 208 may contain one or more components or devices. Persistent storage 208 may be a hard drive, a flash memory, a rewritable optical disk, a rewritable magnetic tape, or some combination of the above. The media used by persistent storage 208 also may be removable such as, but not limited to, a removable hard drive.

Communications unit 210 provides for communications with other data processing systems or devices. In these examples, communications unit 210 is a network interface card. Modems, cable modem and Ethernet cards are just a few of the currently available types of network interface adapters. Communications unit 210 may provide communications through the use of either or both physical and wireless communications links.

Input/output unit 212 enables input and output of data with other devices that may be connected to data processing system 200. In some embodiments, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer readable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. For example, a storage device in data processing system 200 is any hardware apparatus that may store data. Memory 206, persistent storage 208, and computer readable media 218 are examples of storage devices in a tangible form.

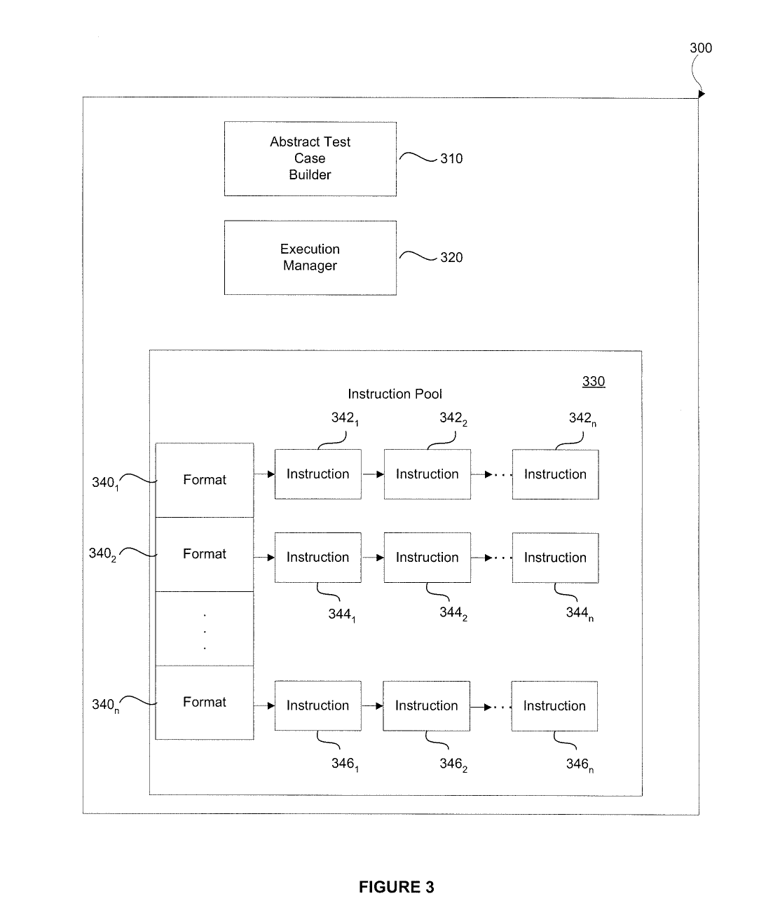

FIG. 3 is an embodiment of a system 300 for processor verification. System 300 may be implemented on a data processing system or platform such as, but not limited to, client 110 or server 140 depicted in FIG. 1 and/or system 200 depicted in FIG. 2. In the embodiment illustrated in FIG. 3, system 300 includes an abstract test case builder 310, a run-time execution manager 320, and an instruction pool 330. Abstract test case builder 310 and run-time execution manager 320 may comprise software programs executable by a processing unit. Abstract test case builder 310 builds an abstract test case to be used for processor verification. A test case includes a series or stream of instructions that are executed in hardware. The test case may also be simulated using software and the results compared with the hardware results to verify the processor. Abstract test case builder 310 builds or creates an abstract test case that execution manager 320 uses to build a non-abstract or real test that is executed in the hardware. The abstract test case includes a stream of instructions where one or more of the instructions are abstract instructions (i.e., abstract in form). In some embodiments, the abstract test case includes all abstract instructions. However, it should be understood that in some embodiments, the abstract test case may also include one or more real instructions in combination with one or more abstract instructions. Further, the abstract test case may include a number of different abstract instructions for each different instruction format.

Instruction pool 330 includes a number of different, predefined non-abstract or real instructions corresponding to the different instruction formats available for verifying or testing the selected processor architecture. For example, in some embodiments, instruction pool 330 may comprise a table defining a number of different instructions each corresponding to a different instruction format. In FIG. 3, different instruction formats are depicted as formats 340₁-340ₙ. For each format 340₁-340ₙ, a number of different instructions are defined which may include different operating codes (opcodes) and/or extended opcodes as well as defining particular registers or other information for building a real test case for processor verification. In the embodiment illustrated in FIG. 3, format 340₁ includes instructions 342₁-342ₙ, format 340₂. includes instructions 344₁-344ₙ, and format 340ₙ includes instructions 346₁-346ₙ. Thus, for example, for format 340₁, each of instructions 342₁-342ₙ define a different instruction but each having the same general instruction format.

Execution manager 320 receives and/or otherwise processes the abstract test case built by abstract test case builder 310 by modifying, substituting and/or otherwise replacing the abstract instructions in the abstract test case with real instructions selected from instruction pool 330. In some embodiments, execution manager 320 randomly selects a particular instruction from instruction pool 330. However, it should be understood that other methods may be used for determining which real instruction to select from instruction pool 330 for substituting for an abstract instruction. Execution manager 320 identifies the format of the abstract instruction and selects a real instruction from instruction pool 330 corresponding to the same format. Thus, the abstract test case may include a number of instances of the same abstract instruction format while execution manager 320 randomly selects different real instructions from instruction pool 330 corresponding to the abstract instruction format. Accordingly, the abstract test case enables different instruction streams to be built based on a particular abstract test case.

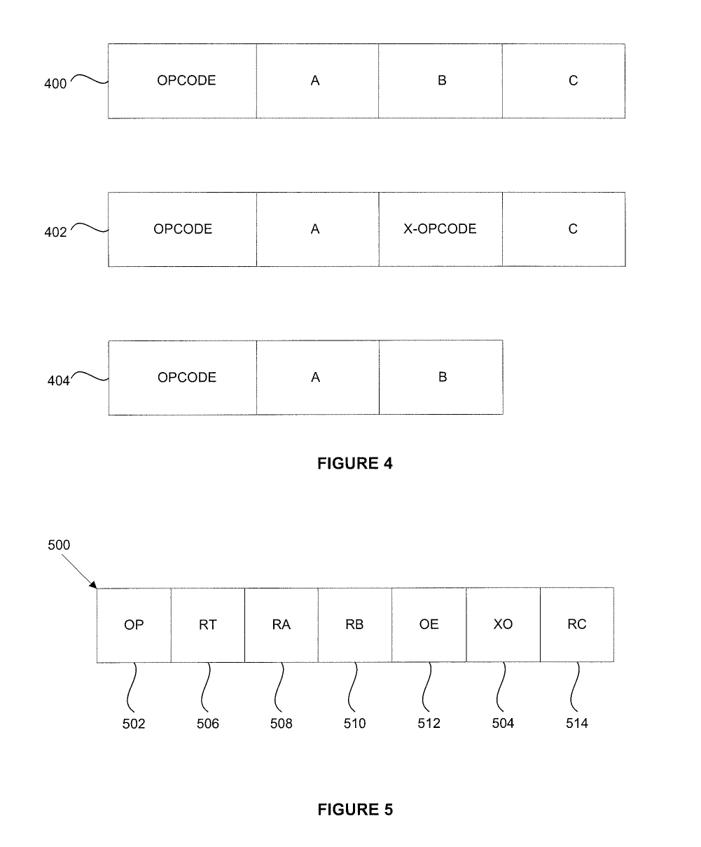

FIG. 4 is a diagram illustrating several different mnemonic representations of different instruction formats. For example, in the embodiment illustrated in FIG. 4, there are illustrated instruction formats 400, 402 and 404. Each instruction format 400, 402 and 404 illustrated in FIG. 4 is a mnemonic representation of a particular instruction format which may include an opcode, a designation of one or more registers (e.g., designated as A, B, and C in FIG. 4) an extended opcode (e.g., indicated by x-op code in FIG. 4), and/or another designation applicable to the particular instruction format. It should be understood that a particular processor architecture may include a greater or fewer number of available instruction formats for testing the particular processor's architecture. As an exemplary illustration, format 402 may correspond to a floating point opcode instruction format where register A is designated as the target register, register C is designated as a source register, and the extended opcode (x-opcode) corresponds to a particular floating point opcode function such as add, subtract, etc.

FIG. 5 is a diagram illustrating an abstract instruction 500 in accordance with aspects of the present disclosure. In the embodiment illustrated in FIG. 5, a single abstract instruction word is illustrated; however, it should be understood that multiple abstract and non-abstract or real instruction words may be combined to build an abstract test case for processor verification. In the embodiment illustrated in FIG. 5, abstract instruction 500 includes an opcode identifier 502, an extended opcode identifier 504, register identifiers 506, 508 and 510, an exception identifier 512, and an indexing identifier 514. It should be understood that the abstract instruction will vary based on the format of the particular instruction. In the embodiment illustrated in FIG. 5, abstract instruction 500 includes an extended opcode identifier 504 for including an extended opcode in the non-abstract or real instruction word; however, it should be understood that different instruction formats may omit an extended opcode. For example, for a particular instruction format (e.g., a floating point or arithmetic instruction format), there may be a number of different branch functions or operations that may be performed or defined (e.g., add, subtract, etc.). Thus, for some instruction formats, the instruction may include an opcode and a branch or extended opcode. However, for other instruction formats, there may not be any branch or extended opcodes. Further, it should be understood that different formats of instructions may have different designations of register identifiers. In FIG. 5, register identifiers 508 and 510 correspond to source registers, and register identifier 506 corresponds to a target register. In some embodiments, the registers corresponding to register identifiers 506, 508 and 510, the exception identifier 512 and the indexing identifier 514 may be fixed for a particular format or group of instructions. However, the opcode and extended opcode corresponding to respective identifiers 502 and 504 can be changed to form different instructions by execution manager 320 via different real instructions selected by execution manager 320 from instruction pool 330.

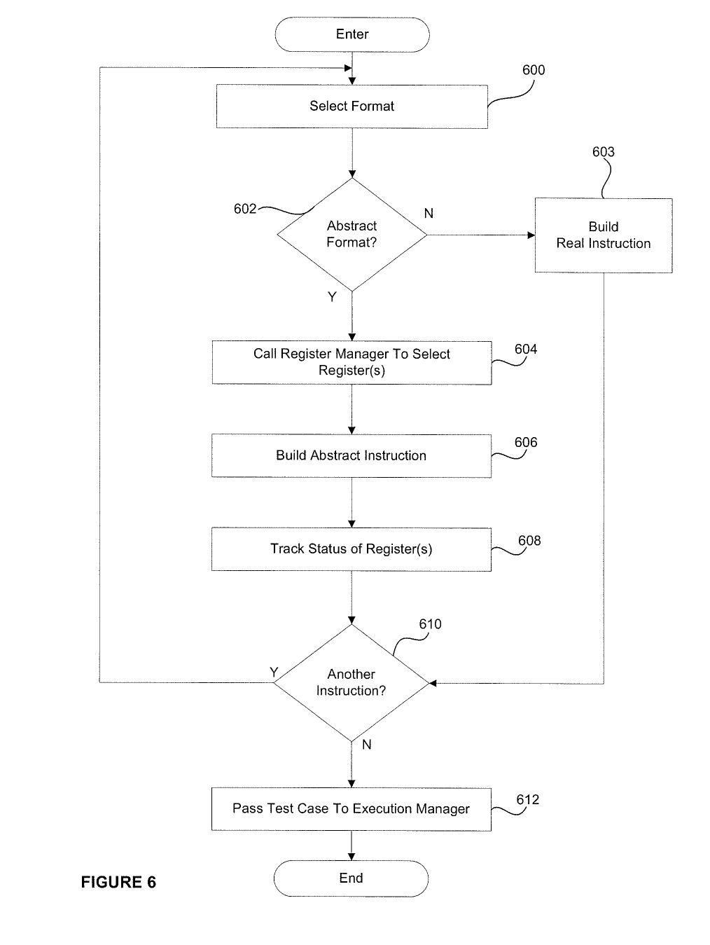

FIG. 6 is a diagram illustrating an embodiment of a method for building an abstract test case in accordance with aspects of the present disclosure. The method begins at block 600, where abstract test case builder 310 selects a particular format for building an instruction. The available formats for verifying a particular hardware architecture may be identified by a user, selected from a listing of available formats, or otherwise indicated. At decisional block 602, a determination is made whether an abstract or real instruction is to be built based on the selected format. As described above, the abstract test case may include a combination of abstract instructions and non-abstract instructions. If the instruction is to be a real or non-abstract instruction at block 602, the method proceeds to block 603, where a real instruction is built. The real instruction may be specified by a user, selected from a listing or other source, or otherwise indicated. If the instruction is to be an abstract instruction at block 602, the method proceeds to block 604, where abstract test case builder 310 calls a register manager or other controller for selecting particular registers based on the selected instruction format. For example, as illustrated and described in connection with FIGS. 4 and 5, different instruction formats may indicate the use of different registers in connection with different opcodes and/or extended opcodes. The particular registers that will be utilized for the particular abstract instruction are selected at block 604.

At block 606, abstract test case builder 310 builds an abstract instruction corresponding to the designated or selected format and including the register information selected at block 604. At block 608, the status of the selected registers are tracked (e.g., to accommodate a comparison of a hardware result of execution of the instruction to a simulated execution). At decisional block 610, a determination is made whether another instruction is to be included in the test case. If so, the method returns to block 600. For example, the above method may be repeated to include any desired quantity of instructions in the test case, including a desired quantity of particular instructions of a specific format. If no further instructions are to be included in the abstract test case, the method proceeds to block 612, where the abstract test case is passed to execution manager 320 for generating a real test case for processor verification.

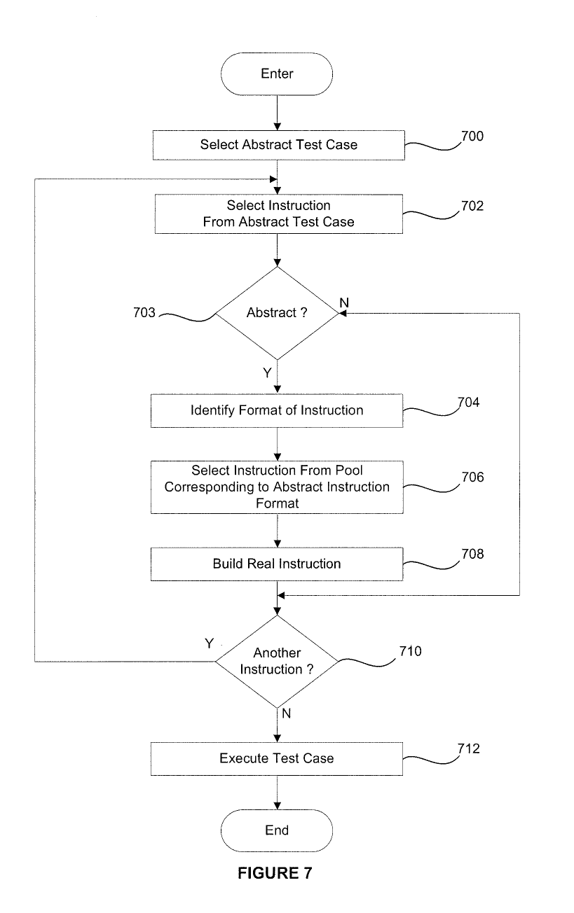

FIG. 7 is a flow diagram illustrating an embodiment of a method for building a real test case for processor verification using an abstract test case. The method begins at block 700, where execution manager 320 selects or otherwise receives an abstract test case. As described above, the abstract test case may include one or more abstract instructions. The abstract test case may also include one or more real or non-abstract instructions. However, it should be understood that the abstract test case may also include all abstract instructions. At block 702, execution manager 320 selects an instruction from the abstract test case. At decisional block 703, a determination is made whether the selected instruction is an abstract instruction. If the selected instruction is an abstract instruction, the method proceeds to block 704, where execution manager 320 identifies the format of the abstract instruction.

At block 706, execution manager 320 accesses instruction pool 330 and selects an instruction from instruction pool 330 corresponding to the identified abstract instruction format. As described above, in some embodiments, execution manager 320 may randomly select an instruction from instruction pool 330 corresponding to the identified instruction format. At block 708, execution manager 320 builds a real instruction by substituting the instruction from instruction pool 330 for the abstract instruction. Substituting the instruction from instruction pool 330 for the abstract instruction may include substituting particular opcodes and/or extended opcodes, as well as specifying particular registers, for building a real instruction word. At decisional block 710, a determination is made whether the abstract test case includes another instruction. If so, the method returns to block 702. Otherwise, the method proceeds to block 712, where execution manager 320 executes the real test case for a processor verification. It should be understood that the above method may be repeated to build additional instruction streams with different instructions (e.g., by selecting different real instructions from instruction pool 330).

Thus, embodiments of the present disclosure enable a number of different instruction test streams to be built from a single abstract test case, thereby reducing the complexity and time for building test streams and performing processor verification using the test streams. Further, since instructions are selected from a format-based instruction pool, embodiments of the present disclosure enabler greater maximization of verifying all instructions in a particular format using a minimum number of test cases.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A method comprising:
identifying a format for an abstract instruction of an abstract test case;
selecting an instruction from an instruction pool corresponding to the identified format; and
generating a real test case for processor verification by modifying the abstract instruction based on the instruction selected from the instruction pool.

2. The method of claim 1, further comprising selecting an instruction from the abstract test case and, in response to identifying that the instruction is an abstract instruction, identifying the format of the abstract instruction.

3. The method of claim 1, further comprising modifying the abstract instruction by including an opcode as defined by the instruction in the instruction pool.

4. The method of claim 1, further comprising modifying the abstract instruction by including an extended opcode as defined by the instruction in the instruction pool.

5. The method of claim 1, further comprising generating the abstract instruction by:
selecting an instruction format based on a processor to be verified;
selecting at least one register to be defined by the abstract instruction; and
building the abstract instruction including an opcode identifier and the at least one register.

6. The method of claim 5, further comprising building the abstract instruction to include an extended opcode identifier.

7. The method of claim 1, wherein selecting the instruction from the instruction pool comprises randomly selecting the instruction from the instruction pool.

8. A system comprising:
a data processing system configured to execute an execution manager, the execution manager configured to execute a real test case for processor verification, the execution manager configured to:
identify a format for an abstract instruction of an abstract test case;
select an instruction from an instruction pool corresponding to the identified format; and
generate the real test case for the processor verification by modifying the abstract instruction based on the instruction selected from the instruction pool.

9. The system of claim 8, wherein the execution manager is configured to select an instruction from the abstract test case and, in response to identifying that the instruction is an abstract instruction, identify the format of the abstract instruction.

10. The system of claim 8, wherein the execution manager is configured to modify the abstract instruction by including an opcode as defined by the instruction in the instruction pool.

11. The system of claim 8, wherein the execution manager is configured to modify the abstract instruction by including an extended opcode as defined by the instruction in the instruction pool.

12. The system of claim 8, wherein the data processing system is configured to execute an abstract instruction builder, the abstract instruction builder configured to:
select an instruction format based on a processor to be verified;
select at least one register to be defined by the abstract instruction; and
build the abstract instruction including an opcode identifier and the at least one register.

13. The system of claim 12, wherein the abstract instruction builder is configured to build the abstract instruction to include an extended opcode identifier.

14. The system of claim 8, wherein the execution manager is configured to randomly select the instruction from the instruction pool.

15. A computer program product for memory management, the computer program product comprising:
a computer readable storage medium having computer readable program code embodied therewith, the computer readable program code comprising computer readable program code configured to:
identify a format for an abstract instruction of an abstract test case;
select an instruction from an instruction pool corresponding to the identified format; and
generate a real test case for processor verification by modifying the abstract instruction based on the instruction selected from the instruction pool.

16. The computer program product of claim 15, wherein the computer readable program code is configured to select an instruction from the abstract test case and, in response to identifying that the instruction is an abstract instruction, identify the format of the abstract instruction.

17. The computer program product of claim 15, wherein the computer readable program code is configured to modify the abstract instruction by including an opcode as defined by the instruction in the instruction pool.

18. The computer program product of claim 15, wherein the computer readable program code is configured to modify the abstract instruction by including an extended opcode as defined by the instruction in the instruction pool.

19. The computer program product of claim 15, further comprising computer readable program code stored on the computer readable storage medium and configured to:
select an instruction format based on a processor to be verified;
select at least one register to be defined by the abstract instruction; and
build the abstract instruction including an opcode identifier and the at least one register.

20. The computer program product of claim 15, wherein the computer readable program code is configured to randomly select the instruction from the instruction pool.

21. A method comprising:
receiving a test case for processor verification;
determining whether the test case includes an abstract instruction; and
in response to determining that the test case includes an abstract instruction:
determining a format of the abstract instruction;
selecting an instruction from an instruction pool based on the format; and
substituting the instruction from the instruction pool for the abstract instruction in the test case.

22. The method of claim 21, further comprising randomly selecting the instruction from the instruction pool.

23. The method of claim 21, further comprising modifying the abstract instruction by including an opcode as defined by the instruction in the instruction pool.

24. The method of claim 21, further comprising modifying the abstract instruction by including an extended opcode as defined by the instruction in the instruction pool.
